(19) United States
(12) Patent Application Publication
(10) Pub. No.: US 2024/0262193 A1
(43) Pub. Date: Aug. 8, 2024

(54) DUAL VIEW VEHICLE DISPLAY

(71) Applicant: PACCAR Inc, Bellevue, WA (US)

(72) Inventor: Andrew Paul Harbach, Argyle, TX (US)

(73) Assignee: PACCAR Inc, Bellevue, WA (US)

(21) Appl. No.: 18/164,804

(22) Filed: Feb. 6, 2023

(51) Int. Cl. B60K 35/00

(52) U.S. Cl. CPC B60K 35/00; B60K 35/22; B60K 35/23; B60K 35/28; B60K 35/29; B60K 2360/1526; B60K 2360/167; B60K 2360/175; B60K 2360/182

(57) ABSTRACT

Systems and methods for providing a dual view display for a vehicle including an autonomous driving system. The autonomous driving system may monitor an environment in which the vehicle is operating, sense a condition in the environment, and determine a vehicle response to the condition including one or more automated vehicle actions. Condition-associated data including information about the sensed/perceived condition and/or the one or more corresponding automated vehicle actions to the condition may be provided to a dual view display system. The dual view display system may determine a notification corresponding to the perceived condition and/or the automated vehicle intention and cause the notification to be displayed on a transparent display. The transparent display provides an operator interface to communicate the vehicle perception/intention to the vehicle operator. The transparent display further provides an external Human-Machine Interface (eHMI) to communicate the vehicle perception/intention to other road users.

### BACKGROUND

Autonomous driving technologies are increasingly being implemented into vehicles on the road that allow the vehicles to perform partial to fully automated driving tasks/actions, such as cruise control, lane keeping, impact collision warning/avoidance, safety-critical functions, self-driving functions, etc. Among other benefits, autonomous (or semi-autonomous) vehicles may improve road safety by reducing accidents caused by human error, such as distracted or impaired driving. However, a lack of communication provided by autonomous vehicles to humans in the vehicle's operating environment may cause operators of autonomous vehicles and other road users to be concerned about the safety of autonomous vehicles and the potential for accidents or malfunction.

While relatively specific examples have been discussed, it should be understood that aspects of the present disclosure should not be limited to solving the specific examples identified in the background.

### SUMMARY

The disclosure generally relates to providing a dual view display for a vehicle according to examples. According to examples, a vehicle may include an autonomous driving system that monitors an environment in which the vehicle is operating, senses a condition in the environment, and determines a vehicle response to the condition, including one or more automated vehicle actions. The dual view display system may determine a notification corresponding to the perceived condition and/or the automated vehicle actions/intention and cause the notification to be displayed on a transparent display. The transparent display provides an operator interface to communicate the vehicle perception/intention to the vehicle operator. The transparent display further provides an external Human-Machine Interface (eHMI) to communicate the vehicle perception/intention to other road users, such as pedestrians, cyclists, and the operators of other vehicles.

According to an aspect, a method is provided, comprising: receiving data associated with a condition perceived in an operating environment of an autonomous vehicle; determining a first notification corresponding to the perceived condition; and causing the first notification to be displayed on a transparent display included in a windowed surface of the autonomous vehicle, wherein the first notification is displayed as a real image on the transparent display and is visible from within the autonomous vehicle and outside the autonomous vehicle.

According to another aspect, a dual view display system is provided, comprising: at least one processor; and a memory including instructions, which when executed by the processor, cause the system to: receive data associated with a condition perceived in an operating environment of an autonomous vehicle; determine a first notification corresponding to the perceived condition; and cause the first notification to be displayed on a transparent display included in a windowed surface of the autonomous vehicle, wherein the first notification is displayed as a real image on the transparent display and is visible from within the autonomous vehicle and outside the autonomous vehicle.

According to another aspect, an autonomous vehicle is provided, comprising: at least one processor; and a memory including instructions, which when executed by the processor, cause the autonomous vehicle to: receive sensor data from one or more sensor on the autonomous vehicle; perceive a condition based on the sensor data, wherein the condition includes another road user in an operating environment of the autonomous vehicle; determine a notification corresponding to the perceived condition; and cause the notification to be displayed on a transparent display included in a windowed surface of the autonomous vehicle, wherein the first notification is displayed as a real image on the transparent display and is visible from within the autonomous vehicle and outside the autonomous vehicle.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following figures:

FIG. 1 is a block diagram illustrating an operating environment in which aspects of a dual view display system may be implemented according to an example;

FIGS. 2A and 2B are illustrations of a vehicle including a dual view display system and displaying a notification on a transparent display according to an example;

FIGS. 3A-3D are illustrations of various example notification display configurations;

FIG. 4 is a flow diagram illustrating processing steps of a method that can be used to providing a dual view display of a notification according to an example;

FIG. 5 is another flow diagram illustrating processing steps of a method that can be used to providing a dual view display of a notification according to an example; and

FIG. 6 is a block diagram illustrating example physical components of a computing device or system with which examples may be practiced.

### DETAILED DESCRIPTION

The following detailed description refers to the accompanying drawings. Wherever possible, the same reference numbers are used in the drawings and the following description to refer to the same or similar elements. While aspects of the present disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the present disclosure, but instead, the proper scope of the present disclosure is defined by the appended claims. The following detailed description is, therefore, not to be taken in a limiting sense.

As mentioned above, although autonomous driving technology provides various benefits, operators of autonomous vehicles and other road users may be concerned about the safety of autonomous vehicles and the potential for accidents or malfunction. In some examples, this may be due in part to reduced or eliminated communication between two humans (i.e., the vehicle operator and another road user) that would typically occur without autonomous driving technology. For instance, a human vehicle operator may typically provide visual cues (a nod, a wave, etc.) to other road users, such as vulnerable road users (VRUs), to communicate to the VRUs that the vehicle operator sees them and is waiting for them to cross. A VRU may include a pedestrian, cyclist, scooter rider, or other unprotected occupant in the vehicle's operating environment. As can be appreciated, because a VRU lacks the protection of safety devices, such as seat belts and airbags, the VRU may be particularly vulnerable in interactions with an autonomous vehicle. VRUs, vehicle operators, other road users may benefit from explicit communications of automated driving actions (e.g., perceptions and/or intentions) of an autonomous vehicle. For example, explicit communications of automated driving actions may facilitate interactions and increase a level of perceived safety and comfort in interacting with the autonomous vehicle.

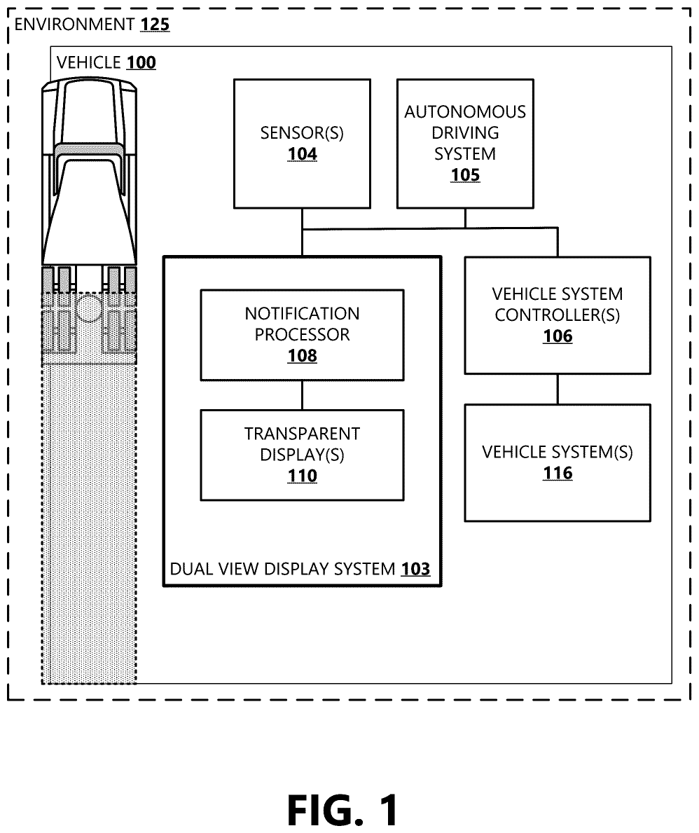

Accordingly, aspects of the present disclosure provide systems and methods for providing a dual view display for a vehicle. According to examples, condition-associated data including information about the sensed/perceived condition and/or the one or more corresponding automated vehicle actions to the condition may be received by a dual view display system. The dual view display system may determine a notification corresponding to the perceived condition and/or the automated vehicle intention and cause the notification to be displayed on a transparent display. The transparent display provides an operator interface to communicate the vehicle perception/intention to the vehicle operator. The transparent display further provides an external Human-Machine Interface (eHMI) to communicate the vehicle perception/intention to other road users. These and other examples are discussed below with reference to FIGS. 1-6.

FIG. 1 is a block diagram illustrating an example operating environment 125 in which a dual view display system 103 may be implemented. With reference now to FIG. 1, the example operating environment 125 includes a vehicle 100. In some examples, and as depicted in various Figures, the vehicle 100 is a truck, such as Class 8 truck. However, the methods and systems can be used by various types of vehicles of all sizes. It will be appreciated that aspects of the disclosed subject matter may also have wide application and, therefore, may be suitable for use with any type of vehicle, such as passenger vehicles, motorcycles, buses, light, medium, and heavy-duty vehicles, trains, boats, yachts, motor homes, etc. Accordingly, the following descriptions and illustrations herein should be considered illustrative in nature and, thus, not limiting the scope of the claimed subject matter.

As shown in FIG. 1, the vehicle 100 includes an autonomous driving system 105 and a dual view display system 103. For instance, the vehicle 100 may be an autonomous vehicle having a level of automation between partial and full automation. In some examples, the dual view display system 103 and the autonomous driving system 105 are communicatively connected. In other examples, the dual view display system 103 may be included in the autonomous driving system 105 or the autonomous driving system 105 may be included in the dual view display system 103. According to examples, the dual view display system 103 provides notifications of perceptions and/or intentions of the vehicle 100 to be displayed on a transparent display 110 included in the vehicle 100. The autonomous driving system 105 may include one or more autonomous vehicle technologies that allow the vehicle 100 to perform one or more automated driving tasks/actions. For instance, the autonomous driving system 105 provides autonomous driving functionality to the vehicle 100. Non-limiting examples of autonomous driving functionalities include cruise control, lane keeping, impact collision warning/avoidance, safety-critical functions, self-driving functions, etc.

According to examples, the autonomous driving system 105 includes or is communicatively connected to a plurality of sensors 104. The sensors 104 receive sensory input about the environment 125 in which the vehicle 100 is operating. In some examples, the autonomous driving system 105 generates and maintains a map of the environment 125 based on a variety of sensor data provided by various sensors 104. For instance, the vehicle may include one or a combination of radar sensors, video camera, lidar (light detection and ranging), ultrasonic, or other sensors that may be used to monitor one or more conditions of the operating environment 125. Conditions of the operating environment 125 may include a detection of nearby vehicles, traffic lights, road signs, objects (e.g., other vehicles, vulnerable road users (VRUs), animals), lane markings, road edges, curbs, etc. A VRU may include a pedestrian, cyclist, scooter rider, or other unprotected occupant in the vehicle's operating environment 125. The sensors 104 may be connected to the vehicle 100 in one or more desired sensing locations. As can be appreciated, the location, type, and number of sensors 104 that are used may depend upon a particular application and can be modified as conditions dictate. For instance, various external sensors 104 may be placed around a vehicle 100 to form a sensing area (e.g., a forward sensing zone, side sensing zones, and a rear sensing zone). The vehicle 100 may further include various other vehicle sensors, such as brake sensors, a throttle sensor, a suspension sensor, tire pressure sensors, vehicle inertial sensor(s), a wheel speed sensor, a vehicle speed sensor, a seat belt sensor, temperature sensors, accelerometers, a steering angle sensor, driver monitoring sensors, moisture sensors, etc. The above sensors 104 may be used individually or in conjunction with each other.

In some examples, the autonomous driving system 105 processes sensor data to monitor the operating environment 125, perceive condition(s) of the environment 125, and determine one or more automated driving tasks/actions to perform based on the condition(s). In some examples, the autonomous driving system 105 uses rules, obstacle avoidance algorithms, predictive modeling, object recognition, and other technologies to perceive conditions and to determine a corresponding automated driving tasks/action(s) to perform. The autonomous driving system 105 may be configured to follow traffic rules and navigate objects and other obstacles. Example automated driving tasks/action(s) may include one or a combination of brake control, throttle control, steering control, suspension control, transmission control, other chassis control, drive state control, lighting and horn control, etc. According to examples, the autonomous driving system 105 may output control signals or other instructions to one or more vehicle system controllers 106 to cause one or more vehicle systems 116 to perform the determined automated driving action(s). The term “vehicle intention” is used herein to describe one or more automated driving action(s) the vehicle 100 determines to perform or performs. In some examples, the vehicle intention is in response to a perceived condition. For instance, the vehicle 100 may automatically brake/stop based on perceiving a VRU, such as a pedestrian, on the road or in the vehicle's current path. As another example, the vehicle 100 may steer into a parking space based on perceiving an available parking space.

In some implementations, the autonomous driving system 105 may output data associated with a perceived condition (herein referred to as “condition-associated data”) to the dual view display system 103. For example, the dual view display system 103 may receive condition-associated data including signals or other instructions associated with a perceived condition (e.g., the VRU detection, the available parking space) and/or the corresponding vehicle intention (e.g., braking/stopping for the pedestrian, turning into the available parking space). According to an example implementation, the dual view display system 103 may include a notification processor 108 and one or more transparent displays 110. For instance, the notification processor 108 may process the received condition-associated data and determine a notification corresponding to the condition to communicate to the operator of the vehicle 100 and to another road user in the environment 125 via a transparent display 110.

In some examples, each of the one or more transparent display(s) 110 may comprise or be included in a windowed surface (e.g., windshield, side windows, back window) of the vehicle 100 using one of various transparent display technologies. The transparent display(s) 110 may be mounted onto or integrated into a vehicle window or sections thereof. According to examples, the transparent display 110 provides an interface between the vehicle 100 and other road users, where a notification may be displayed on the transparent display 110 as a real image (e.g., viewable from inside and outside the vehicle 100). In one example, the transparent display 110 includes an OLED (organic light-emitting diode) transparent display or an LCD (liquid crystal display) transparent display. In another example, the transparent display 110 uses a projection display technology, such as LCD technology, DLP (digital light processing) technology, LCOS (liquid crystal on silicon) technology, UV laser film excitation technology, HOE (Hologram Optical Element) technology, etc. Other types of transparent display 110 technologies that allow for a background of the display to be transparent when displaying a notification are possible and are within the scope of the present disclosure.

According to examples, the dual view display system 103 uses the transparent display 110 as an external human-machine interface (eHMI) to communicate externally to other road users. Additionally, the dual view display system 103 uses the transparent display 110 as an operator interface to display the notification and other information such as speed, navigation, autonomous driving status, etc., without requiring the operator to take their eyes off the road or task at hand. For instance, the notification may include text and/or symbols and provide an explicit communication of the perceived condition and/or the corresponding action of the vehicle 100. Accordingly, both the operator of the vehicle 100 and other road users may be informed about perceptions/intentions of the vehicle 100, which may increase a level of perceived safety and comfort in interacting with the (autonomous) vehicle 100, where communication between two humans (i.e., the vehicle operator and another road user) may be reduced or non-existent. In some examples, the dual view display system 103 may also use another type of display technology to display the notification, such external vehicle projection display technology to project the notification onto the road surface.

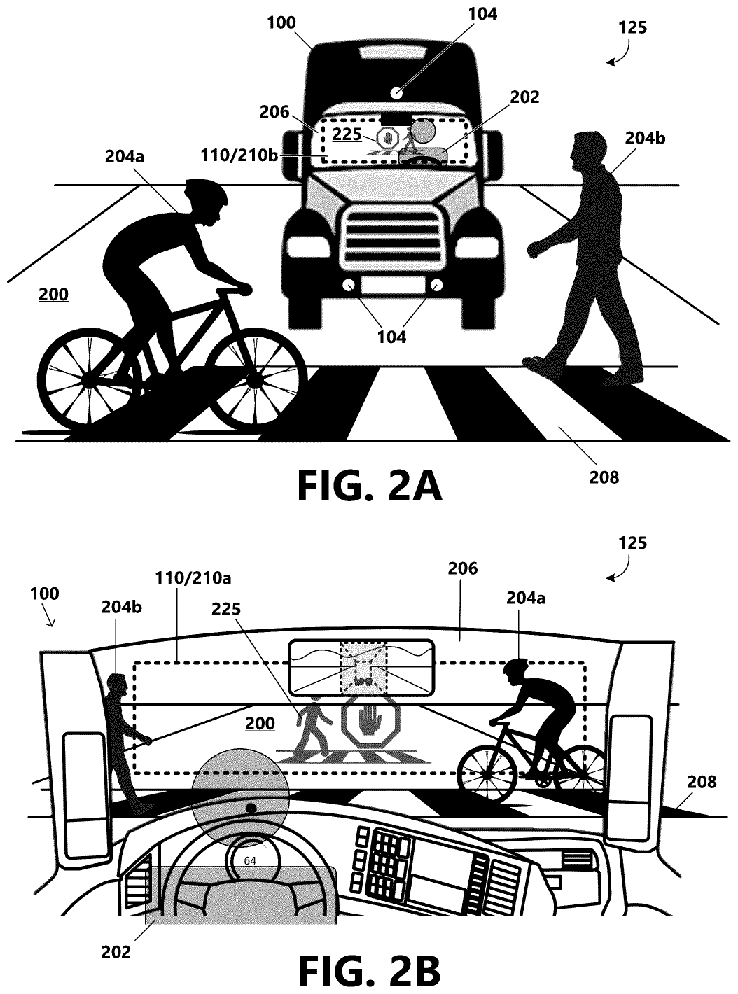

In some examples, the notification processor 108 processes received condition-associated data to determine whether a perceived condition includes detection of a VRU. As mentioned previously, a VRU may not be safely guarded by a vehicle structure and may lack the protection of safety devices such as seat belts and airbags. Thus, VRUs in the operating environment 125 may be particularly vulnerable to actions of the vehicle 100 and may benefit from explicit communication from the vehicle 100 of its perceptions and/or intentions. In some examples, when a determination is made that a perceived condition includes detection of a VRU, the notification processor 108 may generate a notification including text and/or symbols to notify the VRU that the VRU has been perceived. In other examples, the notification informs the VRU of an action the vehicle is taking in response to the perceived VRU. In some examples, the notification that is generated and displayed upon detection of a VRU may be different from the notification that is generated and displayed in other instances (such as when another road user, such as a vehicle, is detected). As can be appreciated, the operator of the vehicle 100 may also benefit from being explicitly informed about perceptions/intentions of the vehicle 100 to increase the operator's level of perceived safety and comfort in operating the (autonomous) vehicle 100, particularly in close proximity to a VRU. Additional details of the dual view display system 103 and notifications provided by the dual view display system 103 are described below with reference to FIGS. 2-6.

FIGS. 2A and 2B depict an example vehicle 100 including an autonomous driving system 105 and a dual view display system 103, where the dual view display system 103 is providing a notification via a transparent display 110. In some examples and as illustrated in FIGS. 2A and 2B, the transparent display 110 is included in a front windshield 206 of the vehicle 100. In other examples, the transparent display 110 may be included in a different and/or additional windowed surface. Although the vehicle 100 in FIGS. 2A and 2B is depicted with a rearview mirror (e.g., a reflective mirror, a digital mirror, or a reflective and digital mirror), in other examples, the vehicle 100 may not include a rearview mirror. FIG. 2A depicts a perspective from outside the vehicle 100 (e.g., as may be seen by another road user 204a and 204b, collectively, “other road users 204”). For instance, the transparent display 110 may be viewed by other road users 204 and may operate as an eHMI 210b for the vehicle 100 to communicate notifications 225 externally to other road users 204. In the examples shown, the other road users 204 are VRUs (e.g., a cyclist (204a) and a pedestrian (204b)). However, in other examples, the other road users 204 may include operators of other vehicles and/or other autonomous vehicles or other users of/near the road). FIG. 2B depicts a perspective from inside the vehicle 100 (e.g., as may be seen by an operator 202 of the vehicle 100). For instance, the transparent display 110 may be viewed by the vehicle operator 202 and may operate as an operator interface 210a, such as a heads-up display (HUD), to communicate notifications 225 and other information at or near the operator's line of sight.

According to examples, the autonomous driving system 105 included in the vehicle 100 may receive sensor data from various sensors 104 and monitor the operating environment 125 of the vehicle 100. For example, the autonomous driving system 105 may perceive the road 200, other road users 204, road markings 208 (e.g., crosswalk), and other objects and determine a corresponding automated driving action(s) to perform. For instance, the autonomous driving system 105 may determine for the vehicle 100 to stop until the vehicle 100 can safely proceed. According to examples, the dual view display system 103 may receive condition-associated data from the autonomous driving system 105 including information about the perceived conditions and/or the determined vehicle intentions. The dual view display system 103 may determine, based on the received condition-associated data, an appropriate notification 225. For instance, the dual view display system 103 may determine a message to communicate to the vehicle operator 202 and to the other road users 204 based on receiving data indicating a VRU on the road 200 and/or indicating the vehicle 100 is stopping for the VRU. As depicted in FIGS. 2A and 2B, the message determined for the notification 225 includes symbols indicating the perception of a VRU and the intention of the vehicle 100 to stop. In other examples, the notification 225 may additionally or alternatively include text. In some examples, the displayed notification 225 may be presented in association with an audible notification and/or other visual cues (e.g., flashing lights).

In some examples, the dual view display system 103 may determine a first notification 225 to communicate to other road users 204 and a second notification 225 to communicate to the vehicle operator 202. According to one example, the first notification 225 and the second notification 225 are displayed at a same time on different locations on the transparent display 110. For example, if the notification includes text, the first notification 225 may be oriented on the transparent display 110 to for the road users 204 to be able to read, while the second notification 225 may be oriented (e.g., in a different location) for the vehicle operator 202 to read. According to another example, the first notification 225 and the second notification 225 are displayed intermittently.

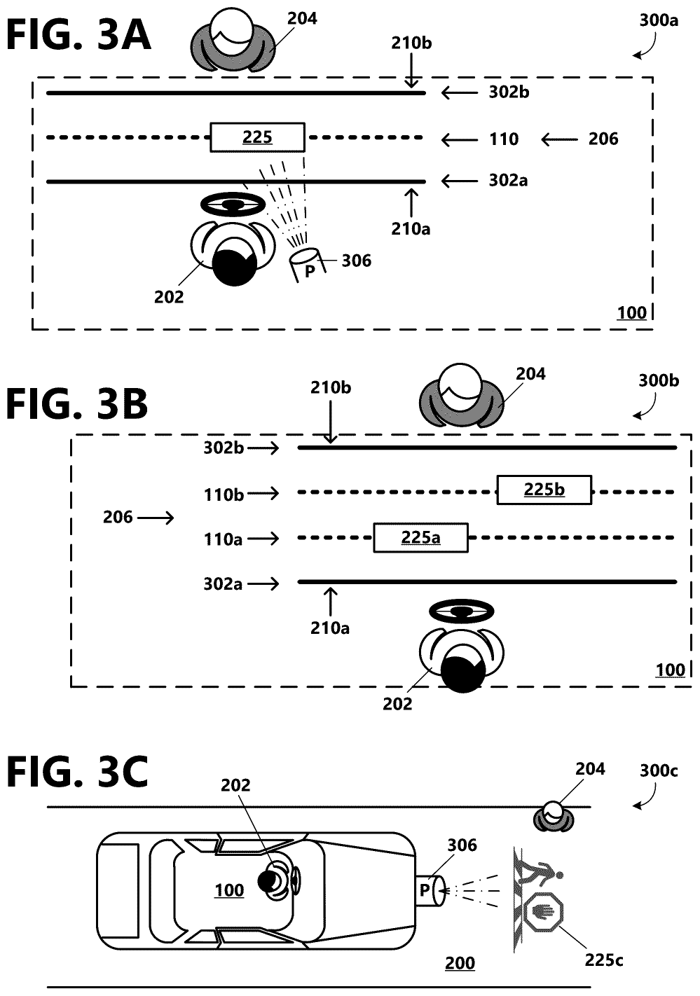

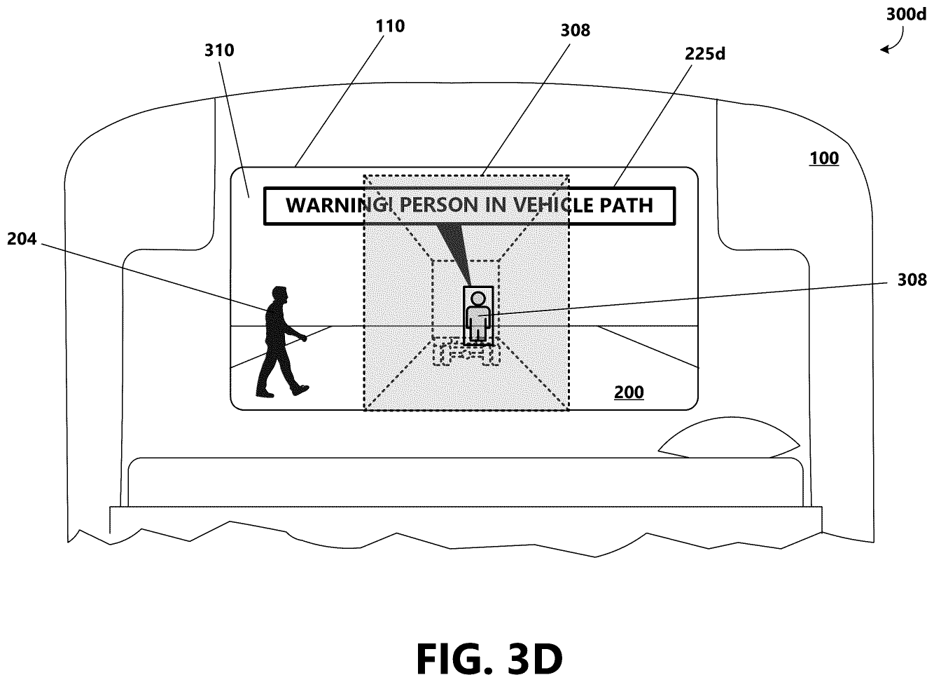

FIGS. 3A-3D include illustrations of various example notification display configurations 300a-300d. For instance, as shown in FIG. 3A, a first example display configuration 300a includes a windshield 206 comprising the transparent display 110 attached to a glass/window surface 302 or disposed between two layers of glass surfaces 302a and 302b (collectively, glass surface 302). For instance, the notification 225 may be projected onto (e.g., by a projector 306) or otherwise displayed a transparent screen, film, or projection display technology included in the transparent display 110. The notification 225 may appear on the glass surface 302 or may appear to be floating at a distance past or in front of the glass surface 302. This may allow the vehicle operator 202 to see the notification 225 while keeping their eyes on the road 200 and may additionally allow another road user 204 to see the notification 225 while encountering an autonomous action of the vehicle 100. In some examples, a plurality of notifications 225 may be displayed on the transparent display 110.

According to another example, and with reference now to FIG. 3B, a second example display configuration 300b is shown. The second example display configuration 300b includes a windshield 206 with two transparent displays 110a and 110b attached to a glass/window surface 302 or disposed between two layers of glass surfaces 302a and 302b (collectively, glass surface 302). For instance, a first notification 225a may be projected onto (e.g., by a projector 306) or otherwise displayed on a first transparent display 110a and a second notification 225b may be displayed on a second transparent display 110b. In such examples, the first transparent display 110a may operate as an operator interface 210a and the second transparent display 110b may operate as an eHMI 210b. In some examples, a pattern may be displayed on the second transparent display 110b in line with the first notification 225a, such that the first notification 225a may be obfuscated from other road users 204. In some examples, a pattern may be displayed on the first transparent display 110a in line with the second notification 225b, such that the second notification 225b may be obfuscated from the vehicle operator 202.

According to another example, and with reference now to FIG. 3C, a third example display configuration 300c is shown. In the third example display configuration 300c, a third notification 225c is projected (e.g., by a projector 306) onto the road 200 for display to the vehicle operator 202 and other road users 204. For instance, the third notification 225c may be provided in addition to one or more notifications 225 displayed on a transparent display 110.

According to another example, and with reference now to FIG. 3D, a fourth example display configuration 300d is shown. In the fourth example display configuration 300d, a transparent display 110 is integrated into a rear window of the vehicle 100. According to an example, the dual view display system 103 may generate and display an augmented reality environment 310 on the transparent display 110 including a combination of a scene captured by at least one camera and one or more virtual design elements 308. For instance, the augmented reality environment 310 may be generated and displayed using examples described in U.S. Pat. No. 10,373,378 titled “Augmented Reality System for Vehicle Blind Spot Prevention” filed on Jun. 26, 2015, and U.S. Pat. No. 10,909,765 titled “Augmented Reality System for Vehicle Blind Spot Prevention” filed on Jun. 28, 2019, the disclosures of which are incorporated by reference herein in their entireties. In examples, the vehicle operator 202 may be able to view the camera-captured scene as a view augmented by information captured by the one or more cameras, which may allow the operator to view other road users 204 that are not viewable through the transparent display 110 (e.g., other road users 204 who may be behind a trailer of a tractor-trailer vehicle 100). In one embodiment, the virtual design elements 308 are rendered based on the vehicle operator's viewpoint. As depicted in FIG. 3D, the virtual design elements 308 may include, for example, a general outline of an occluding structure, such as a portion of the vehicle 100 (e.g., a trailer of a tractor-trailer vehicle 100) and objects that may be occluded thereby. The virtual design elements 308 may allow the vehicle operator 202 to “see through” the occluding structures, such as the trailer, in order to increase operator visibility, etc. For example, a first VRU may be behind the vehicle 100 and occluded by a vehicle structure. Thus, a virtual design element 308 included in the augmented reality environment 310 may include the first VRU. Additionally, the dual view display system 103 may generate a notification 225d corresponding to the first VRU and include the notification 225d in the augmented reality environment 310. As depicted, the notification 225d may include information about the perception of the first VRU. For instance, the notification 225d may be presented on the transparent display 110 to the vehicle operator 202 and to a second VRU (e.g., other road user 204) and any other road users 204 who may have sight of the transparent display 110. In some examples, sensor data may indicate a detected VRU is in a position where the transparent display 110 may not be visible to the detected VRU. In such cases, the dual view display system 103 may present the notification 225 for display via another display configuration, such as the third example display configuration 300c or another type of notification display.

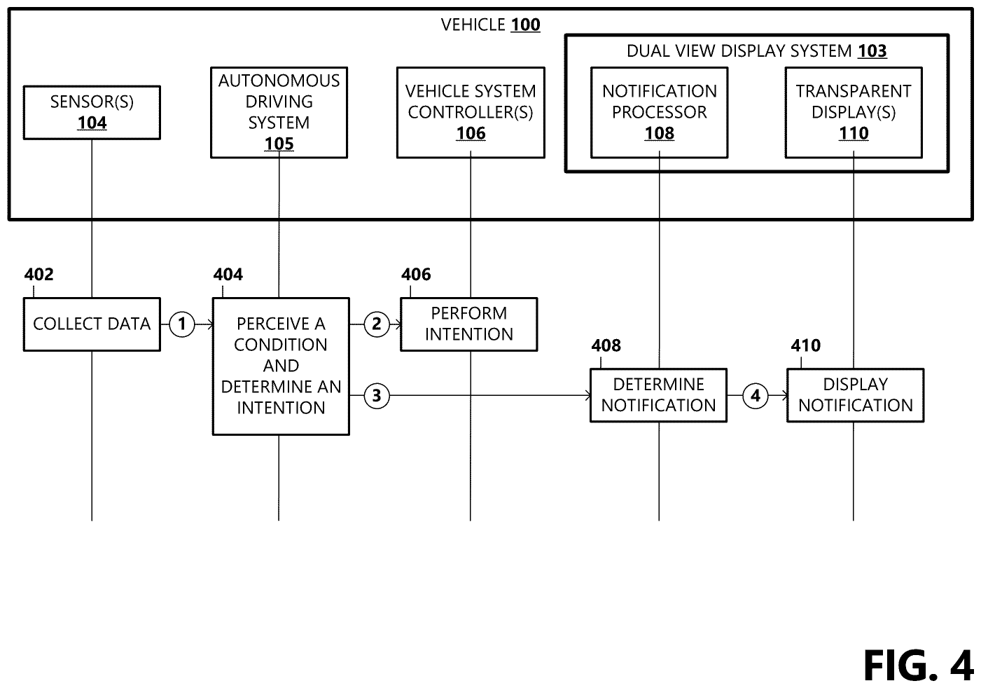

With reference now to FIG. 4, a flow diagram is provided illustrating example processing steps of a method 400 that can be used to provide a dual view display of a notification 225 according to an example. For instance, at operation 402, sensor data may be collected by various sensors 104 included in the vehicle 100. The sensor data may include various sensory inputs about the environment 125 in which the vehicle 100 is operating. For instance, the sensors 104 may include one or a combination of radar sensors, video camera, lidar, and ultrasonic sensors that may collect sensor data and provide the sensor data to the autonomous driving system 105. Circled numeral “1” represents sensor data being transmitted to the autonomous driving system 105.

At operation 404, the autonomous driving system 105 may process the received sensor data to monitor one or more conditions of the operating environment 125. For instance, the autonomous driving system 105 may perceive one or more conditions in the operating environment 125, such as a detection of nearby vehicles, traffic lights, road signs, objects, other road users 204 (e.g., other vehicles, VRUs), lane markings, road edges, curbs, etc. In some examples, the autonomous driving system 105 may determine a corresponding automated driving action(s) to perform based on the perceived condition. As represented by circled numeral “2”, the autonomous driving system 105 may communicate signals or other instructions associated with a perceived condition and/or the corresponding vehicle intention to one or more vehicle controllers 106. For instance, the one or more vehicle controllers 106 may control one or more vehicle systems 116 to execute the determined automated driving action(s) (e.g., control braking, throttle, steering, suspension, transmission, other chassis control, drive state) and cause the vehicle 100 to respond to the perceived conditions in the operating environment 125.

Additionally, and as represented by circled numeral “3”, the autonomous driving system 105 may communicate condition-associated data including signals or other instructions associated with a perceived condition and/or the corresponding vehicle intention to the dual view display system 103. In some examples, at operation 408, the dual view display system 103 may determine whether to generate a notification 225 based on the received condition-associated data. For instance, the notification processor 108 of the dual view display system 103 may determine whether to generate/display a notification 225 based on the type of condition (or combination of multiple conditions) perceived by the autonomous driving system 105 and/or the type of action performed by the vehicle 100 in response to the perceived condition. In other examples, the dual view display system 103 may determine a message for the notification 225. For instance, the message may be intended for the vehicle operator 202 and/or another road user 204. In some examples, the dual view display system 103 may further determine a location/area on the transparent display 110 to display the notification 225. As represented by circled numeral “4”, the notification processor 108 may communicate signals or other instructions associated with determined notification 225 to a transparent display 110 included in the vehicle 100. For instance, the notification 225 may be visible to the vehicle operator 202 inside the vehicle 100 and visible to another road user 204 in the environment 125 outside the vehicle 100.

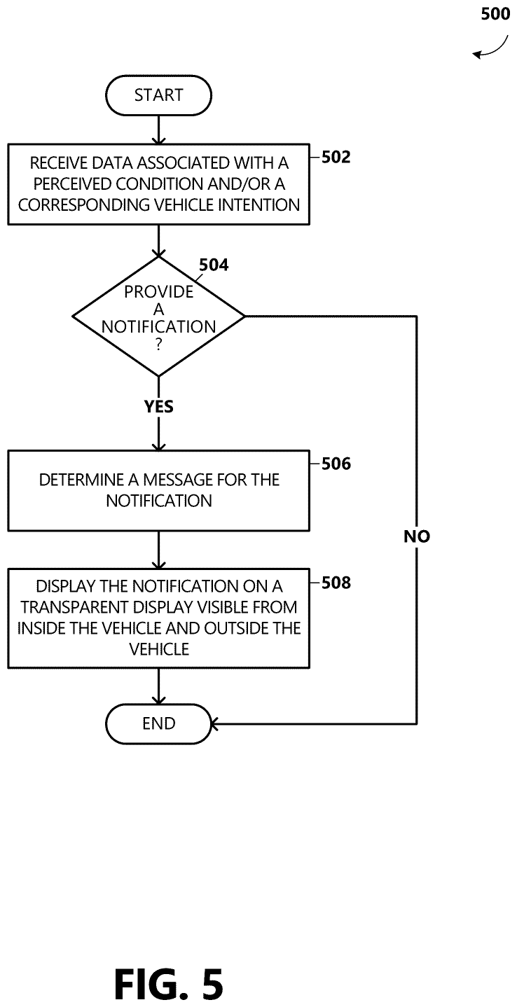

FIG. 5 is a flow diagram illustrating example processing steps of a method 500 that can be used to provide a dual view display of a notification 225 according to an example. For instance, the processing steps may be performed by components of the dual view display system 103. At operation 502, the dual view display system 103 may receive condition-associated data from the autonomous driving system 105 of a vehicle 100. For instance, the condition-associated data may include signals or other instructions associated with a condition perceived by the autonomous driving system 105 and/or one or more automated driving actions determined by the autonomous driving system 105 to be performed in response to the perceived condition.

At decision operation 504, a determination may be made by the dual view display system 103 about whether to provide a notification 225 associated with the received condition-associated data. In some examples, the determination may be based on the type of condition perceived. For instance, the dual view display system 103 may process received condition-associated data and determine a type of condition that is perceived in the environment 125 and/or a type of vehicle intention that is determined for the vehicle 100 to perform in response to the perceived condition. In some examples, the dual view display system 103 may determine whether the type of perceived condition/vehicle intention satisfies one or more rules corresponding to providing explicit communication of a message corresponding to the perceived condition/vehicle intention. As an example, the dual view display system 103 may be configured to provide a notification 225 when the perceived condition includes another road user 204 and where the vehicle intention includes braking or steering to avoid a collision with the other road user 204. As another example, the dual view display system 103 may determine to provide a notification 225 when the when the perceived condition includes a VRU. As another example, the dual view display system 103 may not provide a notification 225 when the perceived condition does not include another road user 204, such as when the vehicle 100 is self-steering to avoid a curb.

When a determination is made to provide a notification 225, at operation 506, a message for the notification 225 may be determined. In some examples, the message may include information corresponding to the perceived condition. In some examples, the message may be one of a plurality of stored messages from which the dual view display system 103 may select a message for the notification 225. For instance, the message may include information about a detected VRU, where the notification 225 may include text or symbols representing the detected VRU. In some examples, the message may additionally or alternatively include information corresponding to the vehicle's intention. For instance, the message may include information about an intention of the vehicle 100 to stop for the detected VRU, where the notification 225 may include text or symbols representing the vehicle's intention to stop.

At operation 508, the notification 225 with the determined message may be displayed on one or more transparent displays 110 included in the vehicle 100. For instance, the notification 225 may be displayed such that it is visible from inside the vehicle 100 to the operator 202 of the vehicle 100 and further visible from outside the vehicle 100 to other road users 204 in the operating environment 125. For example, the notification 225 may be an explicit communication of the perceptions/intentions of the vehicle 100. Such explicit communication of the vehicle's perceptions/intentions may help the vehicle operator 202 and other road users 204 to better understand and, thus, increase their trust in interacting with the (autonomous) vehicle 100.

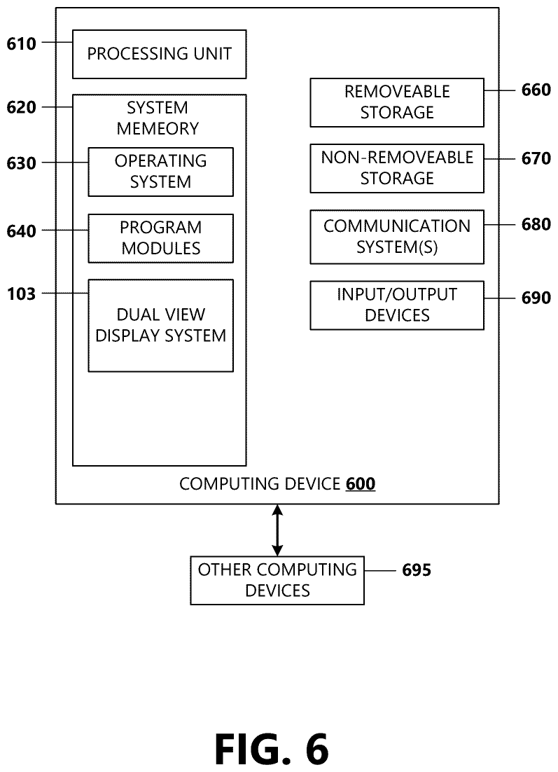

FIG. 6 is a system diagram of a computing device 600 according to an example. As shown in FIG. 6, the physical components (e.g., hardware) of the computing device 600 are illustrated and these physical components may be used to practice the various aspects of the present disclosure.

The computing device 600 may include at least one processing unit 610 and a system memory 620. The system memory 620 may include, but is not limited to, volatile storage (e.g., random access memory), non-volatile storage (e.g., read-only memory), flash memory, or any combination of such memories. The system memory 620 may also include an operating system 630 that controls the operation of the computing device 600 and one or more program modules 640. The program modules 640 may be responsible for performing one more of the operations of the methods described above for providing robust network connectivity. A number of different program modules and data files may be stored in the system memory 620. While executing on the processing unit 610, the program modules 640 may perform the various processes described above. One example program module 640 includes sufficient computer-executable instructions for the dual view display system 103.

The computing device 600 may also have additional features or functionality. For example, the computing device 600 may include additional data storage devices (e.g., removable and/or non-removable storage devices) such as, for example, magnetic disks, optical disks, or tape. These additional storage devices are labeled as a removable storage 660 and a non-removable storage 670.

Examples of the disclosure may also be practiced in an electrical circuit comprising discrete electronic elements, packaged or integrated electronic chips containing logic gates, a circuit utilizing a microprocessor, or on a single chip containing electronic elements or microprocessors. For example, examples of the disclosure may be practiced via a system-on-a-chip (SOC) where each or many of the components illustrated in FIG. 6 may be integrated onto a single integrated circuit. Such a SOC device may include one or more processing units, graphics units, communications units, system virtualization units and various application functionality all of which are integrated (or “burned”) onto the chip substrate as a single integrated circuit.

When operating via a SOC, the functionality, described herein, may be operated via application-specific logic integrated with other components of the computing device 600 on the single integrated circuit (chip). The disclosure may also be practiced using other technologies capable of performing logical operations such as, for example, AND, OR, and NOT, including but not limited to mechanical, optical, fluidic, and quantum technologies.

The computing device 600 may include one or more communication systems 680 that enable the computing device 600 to communicate with other computing devices 695 such as, for example, routing engines, gateways, signings systems and the like. Examples of communication systems 680 include, but are not limited to, wireless communications, wired communications, cellular communications, radio frequency (RF) transmitter, receiver, and/or transceiver circuitry, a Controller Area Network (CAN) bus, a universal serial bus (USB), parallel, serial ports, etc.

The computing device 600 may also have one or more input devices and/or one or more output devices shown as input/output devices 690. These input/output devices 690 may include a keyboard, a sound or voice input device, haptic devices, a touch, force and/or swipe input device, a display, speakers, etc. The aforementioned devices are examples and others may be used.

The term computer-readable media as used herein may include computer storage media. Computer storage media may include volatile and nonvolatile, removable and non-removable media implemented in any method or technology for storage of information, such as computer readable instructions, data structures, or program modules.

The system memory 620, the removable storage 660, and the non-removable storage 670 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information, and which can be accessed by the computing device 600. Any such computer storage media may be part of the computing device 600. Computer storage media does not include a carrier wave or other propagated or modulated data signal.

Programming modules may include routines, programs, components, data structures, and other types of structures that may perform particular tasks or that may implement particular abstract data types. Moreover, aspects may be practiced with other computer system configurations, including hand-held devices, multiprocessor systems, microprocessor-based or programmable user electronics, minicomputers, mainframe computers, and the like. Aspects may also be practiced in distributed computing environments where tasks are performed by remote processing devices that are linked through a communications network. In a distributed computing environment, programming modules may be located in both local and remote memory storage devices.

Aspects may be implemented as a computer process (method), a computing system, or as an article of manufacture, such as a computer program product or computer-readable storage medium. The computer program product may be a computer storage medium readable by a computer system and encoding a computer program of instructions for executing a computer process. Accordingly, hardware or software (including firmware, resident software, micro-code, etc.) may provide aspects discussed herein. Aspects may take the form of a computer program product on a computer-usable or computer-readable storage medium having computer-usable or computer-readable program code embodied in the medium for use by, or in connection with, an instruction execution system.

The description and illustration of one or more aspects provided in this application are intended to provide a thorough and complete disclosure of the full scope of the subject matter to those skilled in the art and are not intended to limit or restrict the scope of the invention as claimed in any way. The aspects, examples, and details provided in this application are considered sufficient to convey possession and enable those skilled in the art to practice the best mode of the claimed invention. Descriptions of structures, resources, operations, and acts considered well-known to those skilled in the art may be brief or omitted to avoid obscuring lesser known or unique aspects of the subject matter of this application. The claimed invention should not be construed as being limited to any embodiment, aspects, example, or detail provided in this application unless expressly stated herein. Regardless of whether shown or described collectively or separately, the various features (both structural and methodological) are intended to be selectively included or omitted to produce an embodiment with a particular set of features. Further, any or all of the functions and acts shown or described may be performed in any order or concurrently. Having been provided with the description and illustration of the present application, one skilled in the art may envision variations, modifications, and alternate embodiments falling within the spirit of the broader aspects of the general inventive concept provided in this application that do not depart from the broader scope of the present disclosure.

1. A method, comprising:
receiving data associated with a condition perceived in an operating environment of an autonomous vehicle;
determining a first notification corresponding to the perceived condition; and
causing the first notification to be displayed on a transparent display disposed between layers of a windowed surface of the autonomous vehicle, wherein the first notification is displayed as a real image on the transparent display and is visible from within the autonomous vehicle and outside the autonomous vehicle.

2. The method of claim 1, wherein receiving data associated with the perceived condition comprises at least one of:
receiving data associated with an object perceived in the operating environment; and
receiving data associated with a vehicle intention including one or more automated driving actions to be performed by the autonomous vehicle responsive to perception of the object.

3. The method of claim 2, wherein the object includes a vulnerable road user.

4. The method of claim 2, wherein the first notification includes an explicit communication of at least one of:
the perceived condition; and
the vehicle intention.

5. The method of claim 1, comprising:
determining a first message including text; and
displaying the first message in an orientation readable from outside the autonomous vehicle.

6. The method of claim 1, comprising:
determining a second message including text; and
displaying the second message in an orientation readable from inside the autonomous vehicle.

7. The method of claim 1, wherein causing the first notification to be displayed on the transparent display comprises causing one or a combination of text and symbols to be displayed in an augmented reality environment on the transparent display.

8. The method of claim 1, further comprising:
determining a second notification corresponding to the perceived condition; and
causing the second notification to be displayed on the transparent display, wherein the second notification is displayed as a real image on the transparent display and is visible from within the vehicle and outside the autonomous vehicle; or
causing the second notification to be projected outside the autonomous vehicle onto a road surface in the operating environment.

9. A dual view display system, comprising:
at least one processor; and
a memory including instructions, which when executed by the processor, cause the system to:
receive data associated with a condition perceived in an operating environment of an autonomous vehicle;
determine a first notification corresponding to the perceived condition; and
cause the first notification to be displayed on a transparent display disposed between layers of a windowed surface of the autonomous vehicle, wherein the first notification is displayed as a real image on the transparent display and is visible from within the autonomous vehicle and outside the autonomous vehicle.

10. The dual view display system of claim 9, wherein the data associated with the perceived condition comprises at least one of:
data associated with an object perceived in the operating environment; and
data associated with a vehicle intention including one or more automated driving actions to be performed by the autonomous vehicle responsive to perception of the object.

11. The dual view display system of claim 10, wherein the one or more automated driving actions include at least one of:
brake control;
throttle control;
steering control;
suspension control;
transmission control; and
drive state control.

12. The dual view display system of claim 10, wherein the object includes another road user in the operating environment outside the autonomous vehicle.

13. The dual view display system of claim 12, wherein the other road user includes a vulnerable road user.

14. The dual view display system of claim 9, wherein the first notification includes at least one of:
a first message including text displayed in an orientation readable from outside the autonomous vehicle; and
a second message including text displayed in an orientation readable from inside the autonomous vehicle.

15. The dual view display system of claim 14, wherein the first and second messages are a same message.

16. The dual view display system of claim 9, wherein the first notification comprises one or a combination of text and symbols.

17. The dual view display system of claim 9, wherein in causing the first notification to be displayed on the transparent display, the system displays the first notification in an augmented reality environment on the transparent display.

18. The dual view display system of claim 9, wherein the instructions further cause the system to:
determine a second notification corresponding to the perceived condition; and
cause the second notification to be displayed on the transparent display, wherein the second notification is displayed as a real image on the transparent display and is visible from within the vehicle and outside the autonomous vehicle; or
cause the second notification to be projected outside the autonomous vehicle onto a road surface in the operating environment.

19. An autonomous vehicle, comprising:
a windowed surface, comprising two layers;
a transparent display disposed between the two layers of the windowed surface;
at least one processor; and
a memory including instructions, which when executed by the processor, cause the autonomous vehicle to:
receive sensor data from one or more sensor on the autonomous vehicle;
perceive a condition based on the sensor data, wherein the condition includes another road user in an operating environment of the autonomous vehicle;
determine a notification corresponding to the perceived condition; and
cause the notification to be displayed on the transparent display disposed between the two layers of the windowed surface of the autonomous vehicle, wherein the first notification is displayed as a real image on the transparent display and is visible from within the autonomous vehicle and outside the autonomous vehicle.

20. The autonomous vehicle of claim 19, wherein:
the instructions further cause the autonomous vehicle to determine one or more actions to be performed by the autonomous vehicle responsive to perception of the other road user; and
the notification includes an explicit communication of at least one of:
the perceived other road user; and
the vehicle intention.
